(19) United States
(12) Patent Application Publication
(10) Pub. No.: US 2025/0239882 A1
(43) Pub. Date: Jul. 24, 2025

(54) Mobile Power Station

(71) Applicant: Greenworks (Jiangsu) Co., Ltd, Changzhou (CN)

(72) Inventors: Nicholas Suchoza, Mooresville, NC (US); Kai Wang, Changzhou, Jiangsu (CN); Hua Zhu, Changzhou, Jiangsu (CN); Jonas Bergstroem, Malmo (SE); David Sargent, Mooresville, NC (US); Yin Chen, Changzhou, Jiangsu (CN); Min Yang, Changzhou, Jiangsu (CN); Troy Efird, Mooresville, NC (US); David Chreene, Mooresville, NC (US); Ernest Spangler, Mooresville, NC (US)

(21) Appl. No.: 19/176,139

(22) Filed: Apr. 10, 2025

Related U.S. Application Data
(63) Continuation of application No. PCT/CN2022/124518, filed on Oct. 11, 2022.

(51) Int. Cl. H02J 7/35; B62D 33/04; H02J 7/00

(52) U.S. Cl. CPC H02J 7/35; B62D 33/04; H02J 7/0042; H02J 7/0047

(57) ABSTRACT

A mobile power station is disclosed. The mobile power station includes an enclosure configured to be mounted on a wheeled chassis; an electrical system positioned in the enclosure, the electrical system including an electrical storage unit and is configured to receive and supply electric energy; and at least one charging bank electrically connected to the electrical system, the at least one charging bank configured to transmit electric energy from the electrical system to an electric device.

### CROSS REFERENCE TO RELATED APPLICATIONS

The present application is a Continuation application of PCT Application No. PCT/CN2022/124518 filed on Oct. 11, 2022, the contents of which are incorporated herein by reference in their entirety.

### BACKGROUND OF THE INVENTION

This invention relates generally to a mobile power station and more particularly to a mobile power station configured to receive and support outdoor power equipment, vehicles, and/or devices.

### BACKGROUND

Various types of vehicles are known for moving equipment. For example, vehicles such as utility trailers or trucks can be configured for various kinds of loads from general purpose configurations to more specialized configurations. It is common for utility trailers to be used to transport and store outdoor power equipment. However, conventional utility trailers are not configured to receive and efficiently charge and provide maintenance facilities for battery powered outdoor power equipment, vehicles, and/or devices because outdoor power equipment has generally utilized internal combustion engines.

One problem with known vehicles is that they do not provide an electrical power supply, specialized storage, and charging capabilities, for battery powered outdoor power equipment, vehicles, and/or devices.

### BRIEF SUMMARY OF THE INVENTION

These problems are addressed by a mobile power station that is configured to store and transport battery powered outdoor power equipment. More specifically the mobile power station disclosed herein is configured to provide charging capabilities both when the outdoor power equipment is in transport from one location to another location and when the mobile power station is parked.

According to one aspect of the invention, a mobile power station includes an enclosure configured to be mounted on a wheeled chassis; an electrical system positioned in the enclosure, the electrical system including an electrical storage unit and is configured to receive and supply electric energy; and at least one charging bank electrically connected to the electrical system, the at least one charging bank configured to transmit electric energy from the electrical system to an electric device.

According to one aspect of the technology described herein, a utility trailer includes including a frame; an enclosure supported by the frame; wheels connected to and supporting the frame; an electrical system positioned in the enclosure, the electrical system including an electrical storage unit and is configured to receive and supply electric energy; and at least one charging bank electrically connected to the electrical system, the at least one charging bank configured to transmit electric energy from the electrical system to an electric device.

### BRIEF DESCRIPTION OF THE DRAWINGS

The invention may be best understood by reference to the following description taken in conjunction with the accompanying drawing figures in which:

FIG. 1 is a front perspective view of a mobile power station in the form of a utility trailer;

FIG. 2 is a rear perspective view of the utility trailer of FIG. 1;

FIG. 3 is a rear view of the utility trailer of FIG. 1, with certain parts removed;

FIG. 4 is a right-side perspective view of the utility trailer of FIG. 1, with certain parts removed; and

FIG. 5 is a left side perspective view of the utility trailer of FIG. 1, with certain parts removed.

### DETAILED DESCRIPTION OF THE INVENTION

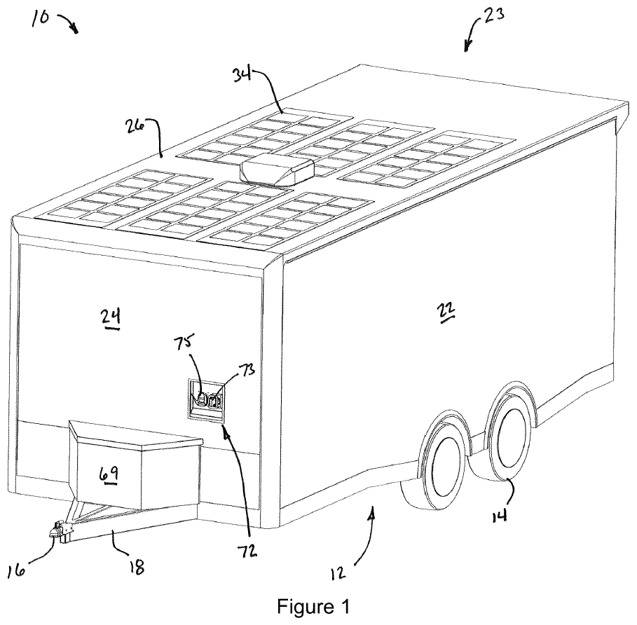

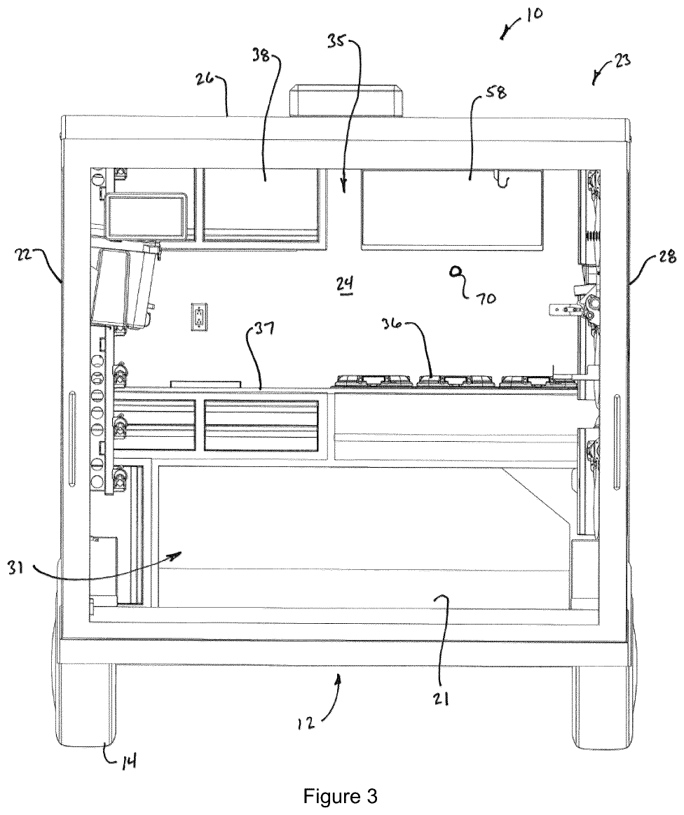

Referring to the drawings wherein identical reference numerals denote the same elements throughout the various views, FIGS. 1-5 show a representative embodiment of a mobile power station 10. Mobile power station 10 is configured to provide secure, productive, and efficient means to power a full array of battery powered outdoor equipment, vehicles, and/or devices.

As illustrated, the mobile power station 10 is a utility trailer; however, other forms of mobile power stations may be used, such as box trucks, pickup trucks, or other types of enclosures mounted to a wheeled chassis. For purposes of clarity, the term enclosure is defined as a surrounding that at least partially encloses an item and does not necessarily imply that it encloses on all sides.

The utility trailer 10 includes a wheeled chassis in the form of a frame 12 supported by at least one pair of wheels 14 mounted to the frame 12. It should be appreciated that the term wheeled chassis may also include a unit body structure where wheels are directly mounted to a body or enclosure and the body or enclosure act as the frame. It should be appreciated that the frame 12 may be made of steel, aluminum, or any other suitable material. The frame 12 extends from a hitch 16 connected to a tongue 18 of the frame 12 to a rear section 20. The hitch 16 allows the trailer 10 to be connected to a vehicle for towing.

The frame 12 supports an enclosure 23 having a floor 21, a left side wall 22, a front side wall 24, a roof 26, a right-side wall 28, and a rear wall 29. The rear wall 29 is configured to operate as a door and ramp to allow access into an interior space 31 of the enclosure 23 of the trailer 10. An array of solar panels 34 is positioned on the roof 26. The solar panels 34 are configured to provide electricity to an electrical system 35.

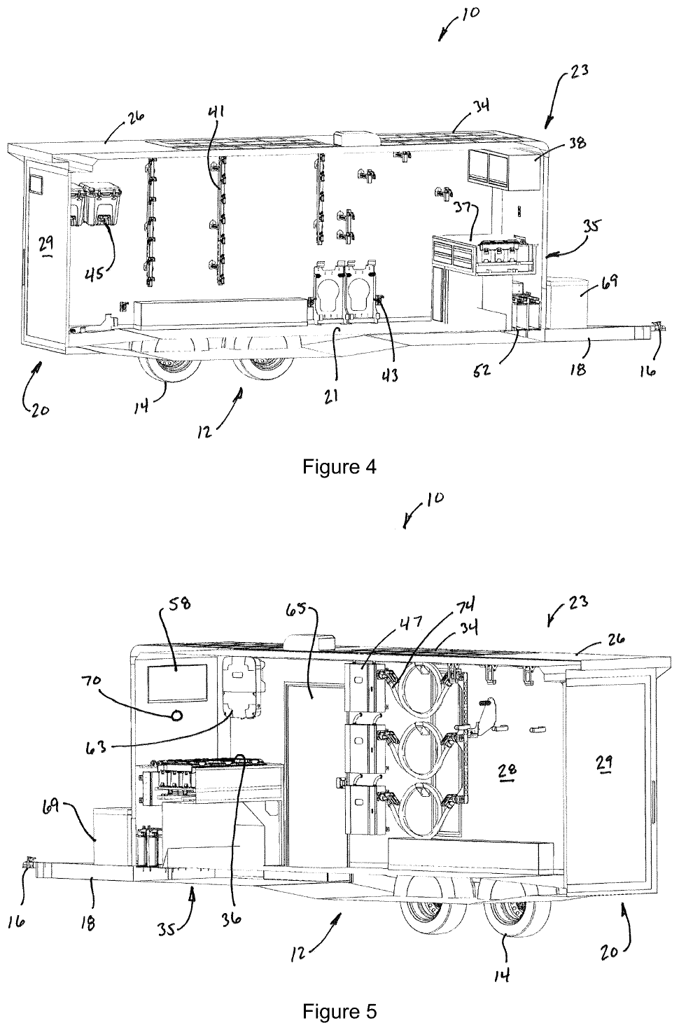

The electrical system 35 includes a battery pack 52, as shown in FIG. 4. According to the illustrated embodiment, the battery pack 52 is a 400 V, high-output, automotive grade, 26 kwh battery pack with safe lithium iron phosphate (LFP) cell technology. The battery pack 52 is configured to be charged at a rate of up to 350 kw and is configured to be compatible with DC fast charging and/or 240 V charging using a standard J1772 plug, allowing the battery pack 52 to be fully charged in as little as thirty minutes. The battery pack 52 is also configured to be charged from the solar panels 34. According to the illustrated embodiment, the solar panels 34 provide 1200 W of output.

The electrical system 35 is configured to provide electrical power from the battery pack 52 to charging stations such as small equipment charging stations 36 positioned on a cabinet shelf 37. The charging stations 36 charge individual batteries 39 for use in small equipment. The cabinet shelf 37 is positioned within the space 31 at an interior surface of front wall 24. At least one general purpose storage cabinet 38 is positioned on the front wall 34 above the cabinet shelf 37 within the space 31. The electrical system 35 includes 24 kW of DC charging output, three individual 20 amp 120 V AC circuits and a 15 amp 12 V AC circuit for powering countertop outlets.

All charging stations of the trailer 10 are temperature controlled to provide safe and efficient charging. The utility trailer 10 includes a temperature control system 61 such as an air conditioner, heater, and/or combination air conditioner and heater. The temperature control system 61 is configured to keep major electronic components operating at optimal temperatures and allows for rapid charging handheld batteries at any environmental temperature. According to the illustrated embodiment, the temperature control system 61 is a 1500 BTU thermoelectric air conditioner; however, other suitable cooling and heating systems or ratings may be used.

It is believed, that due to the provision of charging stations 36 and other charging stations, the trailer 10 can be used to reduce the number of necessary batteries needed to complete a typical day of work for a conventional yard crew by 60%.

There are multiple racks 41 position within the space 31. The racks 41 are configured for the vertical storage of lawn equipment such as string trimmers and edgers and to provide electrical charging to lawn equipment stored there. As shown in FIG. 4, the racks 41 are mounted on an interior surface of the left side wall 22. At least one cooler 45 may be mounted on the left side wall 22 between the racks 41 and the rear wall 29. Dedicated outdoor power equipment chargers 43 are provided on wall 22 and configured to provide electrical power to larger outdoor power equipment such as mowers.

Referring now to FIG. 5, additional storage racks and charging equipment can be positioned on an interior surface of the right-side wall 28. A personnel door 65 is positioned within the right-side wall 28. The personnel door 65 and other doors or access points of the utility trailer 10 are equipped with electronic locks to allow multiple employees to enter the trailer without the need to keep doors unlocked throughout the day. The electronic locks can be configured with multiple codes for different personnel.

A video monitor 58 is positioned on the front wall 24. The video monitor 58 is configured to display metrics or visual information such as location, tool usage, battery charge levels, weather, temperatures, and individual test status on a live dashboard. The video monitor 58 is configured to display information received from multiple sources, including but not limited to: data storage incorporated into the video monitor 58, portable data storage such as a USB or thumb drive, computers, electronic devices, and the like. The video monitor 58 can be connected to such devices by the following: with hardware connection such as an ethernet cable, Wi-Fi, cell phone protocols such as 4G or 5G, and the like.

A computer processor 63 is positioned within the space 31 and is configured to collect data regarding charging status better condition and like from the various chargers and outdoor power equipment within the trailer 10. The computer processor 63 can also be connected to a motion activated security camera and security system 70.

The utility trailer 10 is capable of being charged on any US-based EV charger and most workshop infrastructures via CCS combo type I plug J1772 (EV) or a Nema 14-50 outlet (240 V AC) 25+ battery power tools, 36 handheld batteries, and three full-size mowers. The utility trailer 10 includes electrical connections 72. Electrical connections 72 can be configured to include both inputs 73 and outputs 75 to provide for charging of the battery 52 from an external source of electrical energy and/or for powering the electrical system 35, as well as, for powering an external device such as a welder. Electrical sources of electrical energy include EV charging stations and electric power grids as well as any other suitable electrical sources.

The utility trailer 10 includes an access panel 67 positioned on the right wall 28 to allow for access to charging banks 47 within the trailer 10 by outdoor power equipment and other devices to be charged that are positioned outside of the trailer 10. In this way charging can be more efficiently managed during a workday by avoiding the requirement of loading vehicles into the trailer 10 to charge. Each of the charging banks 47 include at least one charging cable 74 for connection to a charging port of an outdoor power machine and/or equipment. As shown, the trailer 10 includes three charging banks 47 and three charging cables 74. The charging cables 74 may be of any suitable length to allow a user to charge an outdoor power machine external to the trailer 10, for example fifteen feet long.

An antenna (not shown) is positioned near the intersection of the front wall 24 in the roof 26. In the illustrated embodiment, the antenna is positioned within the front wall 24.

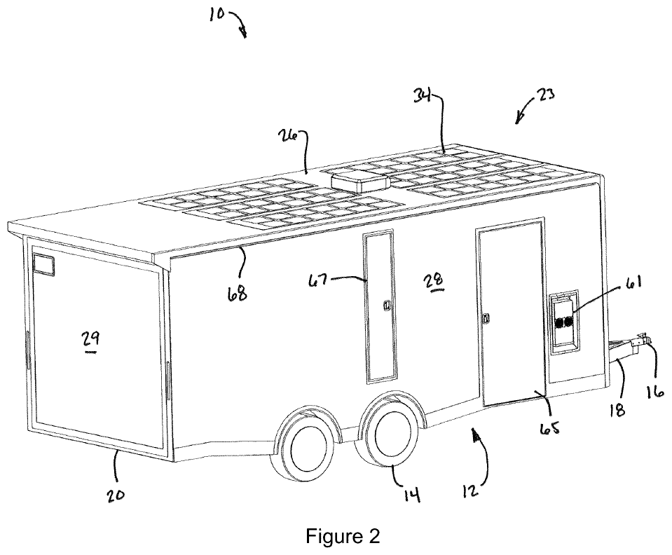

According to the illustrated embodiment, FIG. 2, an exterior light 68 is positioned along the top edge of the right-side wall 28 near the intersection of the right side wall 28 and the roof 26. In other embodiments, the exterior light 68 can be positioned along an exterior upper edge of at least one of the left side wall 22, the front wall 24, the right-side wall 28, and the rear wall 29. As shown, the exterior light 68 is configured as a 19 foot long LED strip. The exterior light 68 is connected to the central control system computer 63 of the trailer 10 and can be controlled by the central control system 63 to indicate various status conditions such as electrical charge. For example, a continuous green light indicates the outdoor power machines are fully charged, a blinking green light indicates the outdoor power machines are in the process of being charged, and a continuous red light indicates a problem with charging. The exterior light 68 can also be utilized as a task light and a theft deterrent.

A storage toolbox 69 is positioned on the tongue 18 near the front wall 24 and is configured to receive various items such as fire suppression equipment and extension cords. Should be appreciated that one of the extension cord stored in the toolbox 69 can be a 30 foot long J1772 extension cord.

The foregoing has described a mobile power station configured for the storage and recharging of electrical outdoor power equipment. All of the features disclosed in this specification, and/or all of the steps of any method or process so disclosed, may be combined in any combination, except combinations where at least some of such features and/or steps are mutually exclusive. Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A utility trailer, comprising:
a frame;
an enclosure supported by the frame;
wheels connected to and supporting the frame;
an electrical system positioned in the enclosure, the electrical system including an electrical storage unit and is configured to receive and supply electric energy; and
at least one charging bank electrically connected to the electrical system, the at least one charging bank configured to transmit electric energy from the electrical system to an electric device.

2. The utility trailer according to claim 1, further including at least one solar panel configured to supply electrical energy to the electrical system.

3. The utility trailer according to claim 1, further including a storage system configured to store multiple electric devices along a wall of the enclosure.

4. The utility trailer according to claim 1, further including an electrical connection configured to connect with an external source of electrical energy.

5. The utility trailer according to claim 4, wherein the external source of electrical energy is a charging station.

6. The utility trailer according to claim 4, wherein the external source of electrical energy is an electric power grid.

7. The utility trailer according to claim 1, further including an access panel in a wall of the enclosure, the access panel providing access to the at least one charging bank externally of the enclosure.

8. The utility trailer according to claim 1, further including a temperature control system to maintain an operating temperature of the electrical system.

9. A utility trailer, comprising:
a frame;
an enclosure supported by the frame;
wheels connected to and supporting the frame;
an electrical system positioned in the enclosure, the electrical system including an electrical storage unit and is configured to receive and supply electric energy;
an electrical connection configured to connect to an external source of electrical energy, wherein the external source of electrical energy charges the electrical storage unit; and
at least one charging bank electrically connected to the electrical system, the at least one charging bank configured to transmit electric energy from the electrical system to outdoor power equipment.

10. The utility trailer according to claim 9, further including at least one solar panel configured to provide electrical energy to the electrical system.

11. The utility trailer according to claim 9, further including a temperature control system to maintain an operating temperature of the electrical system.

12. The utility trailer according to claim 9, further including at least one charging station, the at least one charging station configured to charge at least one battery.

13. The utility trailer according to claim 9, further including a video monitor, the video monitor providing visual information to a user.

14. The utility trailer according to claim 9, further including a vertical storage system configured to store multiple electric devices along a wall of the enclosure.

15. The utility trailer according to claim 9, further including an access panel in a wall of the enclosure, the access panel providing access to the at least one charging bank externally of the enclosure.

16. The utility trailer according to claim 15, wherein the at least one charging bank includes at least one charging cable.

17. The utility trailer according to claim 16, wherein the at least one charging cable is configured to extend through the access panel and charge outdoor power equipment residing externally of the enclosure.

18. The utility trailer according to claim 9, further including a light strip along an exterior of the enclosure, the light strip providing a visual indication of charging.

19. A mobile power station, comprising:
an enclosure configured to be mounted on a wheeled chassis;
an electrical system positioned in the enclosure, the electrical system including an electrical storage unit and is configured to receive and supply electric energy; and
at least one charging bank electrically connected to the electrical system, the at least one charging bank configured to transmit electric energy from the electrical system to an electric device.

20. The mobile power station according to claim 19, wherein the at least one charging bank includes at least one charging cable and wherein the at least one charging cable is configured to charge an electric device residing externally of the enclosure.
